(19) United States
(12) Patent Application Publication
(10) Pub. No.: US 2010/0122736 A1
(43) Pub. Date: May 20, 2010

(54) FAST BACK FLOW DEVICE OF RELIEF VALVE

(76) Inventor: I-JEN HUANG, Taichung (TW)

Correspondence Address: LEONG C LEI, PMB # 1008, 1867 YGNACIO VALLEY ROAD, WALNUT CREEK, CA, 94598, US

(21) Appl. No.: 12/273,560

(22) Filed: Nov. 19, 2008

(51) Int. Cl. G05D 11/00

(52) U.S. Cl. 137/115.16

(57) ABSTRACT

A fast back flow device is provided in a relief valve. A body of the relief valve is constructed in a configuration of dual return flow, wherein the valve body forms a communication passage in a water inlet side thereof to communicate a water releasing channel formed in a lower portion thereof. The water releasing channel receives therein a water releasing valve including a collar and a stacked disk set biased by a resilient element. When the operation of a pump supplies a preset pressure, the water releasing valve assembly is automatically closed and when the pressure drops down to be smaller than the resilient force, the resilient element opens the valve to immediately release water and lower pressure. The assembling of the relief valve is made easier and released unused water can be collected and reused, making the spraying device more environment-protective.

### TECHNICAL FIELD OF THE INVENTION

The present invention generally relates to an improvement of a fast back flow device of a relief valve, which is directly coupled to a lower portion of a relief valve body mounted on a supply tube from a pump and communicates a water releasing channel with a communication passage and receives therein a relief valve assembly to effect, at the time when pressurized water from the pump reaches a preset pressure level, automatic shut-down and water discharge for pressurized water spraying and to effect, at the time when the discharge water pressure drops down to a preset level, synchronous opening of the water releasing valve assembly to immediately lower the water supply pressure and thus ensuring the pressure of the water discharge pipe to quickly lower to almost zero to eliminate water dripping at the water discharge end; this, when cooperating with fluid communication between the water releasing passages of the water inlet side and the water outlet side, allows for collection and reuse of unused released water, eventually making the on/off control of water inlet and water outlet for pump-pressurized spraying complying with the practical safety and hygiene effects of environmental protection and being pollution free.

### DESCRIPTION OF THE PRIOR ART

In the high pressure flow pipe of a conventional agricultural sprayer structure, in order to realize pressure regulated output of water and elimination of water dipping caused by high internal pressure inside the pipe occurring after the device is shut down, a relief valve that functions to regulate the pressure is often provided in the flow passage of the device. By timely relief of pressure, the relief valve may provide immediate relief of the internal pressure of the pipe. However, most relief control is to ensure the operation safety of pipes by properly relief of the high pressure inside the pipes after the operation of the pump is shut down or the water discharge end is closed. The conventional structure of the relief valve generally adopts a stand-along valve structure similar to a check valve, whereby when water is pressurized and supplied by a pump to reach a preset water discharge pressure level, a resilient valve port that functions to prevent reversal flow is set in engagement with other parts to maintain the water discharge pressure at a stable and regulated high pressure level, thereby ensuring the output pressure. In case no relief valve is mounted, when the pump is shut down or stops operation, the sprayer head may continuously eject water due to the slow lowering of internal pressure inside the pipe. This makes a water of water and also causes pollution to the environment. A regular sprayer is provided with a spraying nozzle operating under the constraint of 1.5 kgf/cm² pressure. When the pressure inside the pipe drops to 7 kgf/cm2, a water jet like discharge of water may still be formed, which, together with the slow lowering of the internal pressure, may finally lead to the condition of successive water dripping. This is severe for great length of pipe. Environment leanness and spraying quality may thus be affected. This is generally due to the slow lowering of the internal pressures inside the pipes. In other words, since the internal pressure of the pipes cannot be immediately lowered to a desired low level, the pressure remaining in the pipes causes the water dripping at the sprayer end. It is thus desired to improve the drawback of water dripping caused by residual internal pressure of pipes in order to alleviate or eliminate such a situation and also to make the assembling of the device easy and convenient for combining with the pressure regulation valve assembly and also to effective collect and reuse the released unused water for also improving slipping caused by water dripping and saving water consumption and simplifying installation.

### SUMMARY OF THE INVENTION

As a professional agricultural machinery designer and manufacturer, having years' experience in the design and use of pressure regulated conveyance of water through water supply piping and also having being granted numerous patents, the present inventor made successive study and researches in respect of the water dripping problem caused by residual pressure inside the water piping and eventually invents a fast back flow device of a relief valve in accordance with the present invention, wherein opposite sides of a valve body are provided with simultaneous pressure relief mechanism to ensure immediate lowering of internal pressure and eliminating the water dripping problem. This, together with a unitary-device dual-flow independent return flow or back flow configuration, greatly simplifies the assembling of valve and effectively overcome the drawback of water dripping at the sprayer caused by delayed relief of pressure inside water piping and the problem of inconvenient assembling of the water releasing structure.

An objective of the present invention is directly forming a water releasing channel in a body of a pressure regulation and relief valve at a location under a water passageway of the body and parallel thereto. The water releasing channel receives therein a water releasing valve assembly at a location close to the passageway at the water inlet side. When the pressurizing pump is shut down and the water supply pressure drops to a present pressure level of the water releasing valve assembly, the water releasing valve assembly is opened to release water first, allowing the water inlet side and the water discharge side of the valve body to both effect immediate lowering of pressure. The two water releasing passages are set in communication with each other and are connected through a water conduit to a water reservoir to allow collection and reuse of the unused released water and avoid water dripping at a sprayer head.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a fast relief structure of a relief valve in accordance with the present invention.

FIG. 2 is a perspective view of a valve of the present invention incorporating the fast relief structure.

FIG. 3 is a cross-sectional view illustrating the operation of pressure increasing and water discharge in accordance with the present invention.

FIG. 4 is a cross-sectional view illustrating the operation of water returning and pressure lowering in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

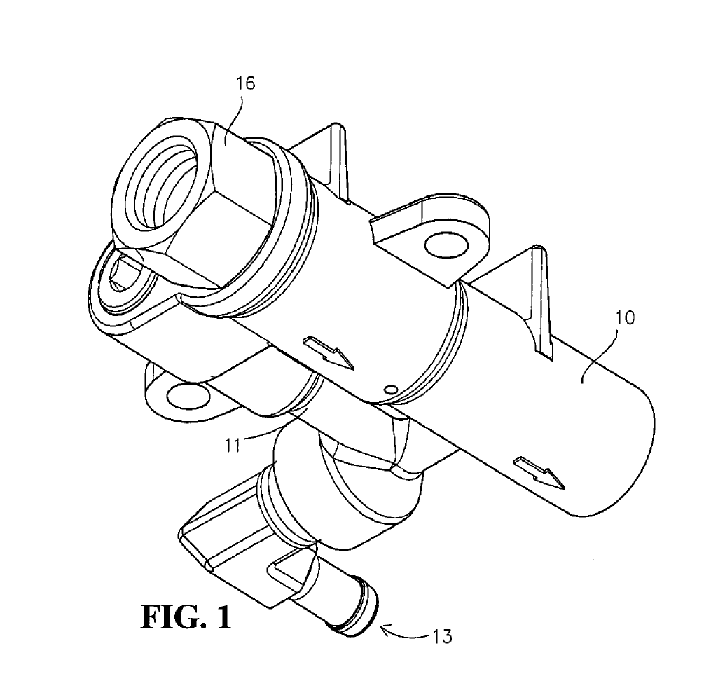

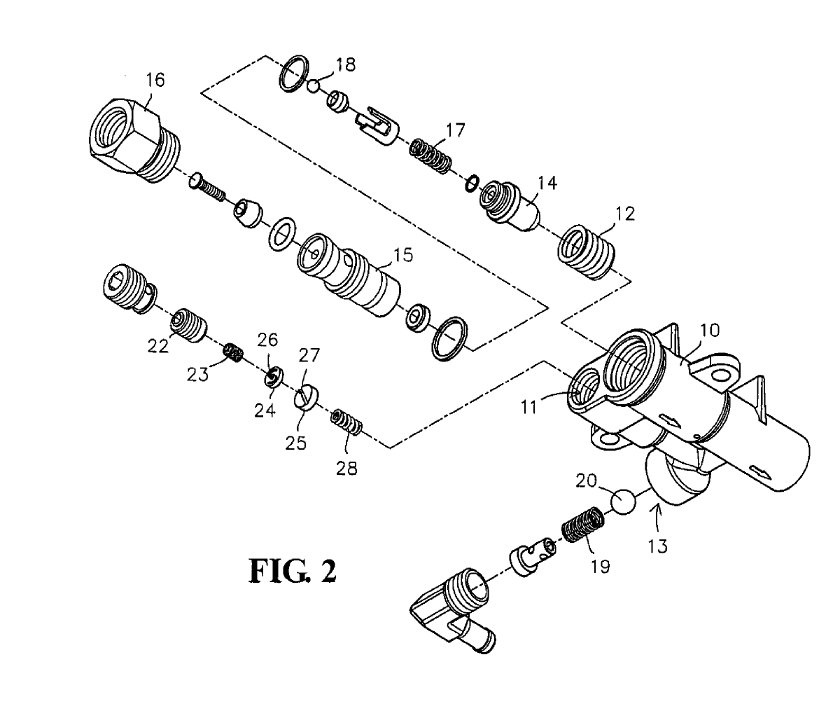

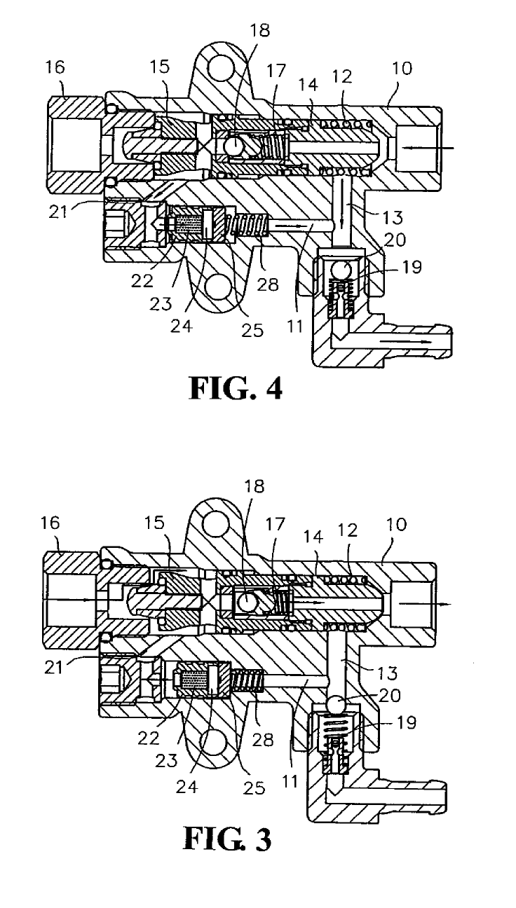

The present invention provides an improved fast back flow device of a relief valve, which is applicable to high pressure spraying operations to automatically open a relief valve assembly at the time when water pressure within an inlet passage drops to a preset pressure level after water supply from a pump is cut off, in order to effect fast lowering of water pressure at a water supply side of the valve and prevent undesired water leaking from occurring at a water discharge side due to pressure accumulation. The construction of the fast back flow device of a relief valve in accordance with the present invention is illustrated in FIGS. 1-4, wherein the entirety of the construction is made in such a way to combine a water releasing valve assembly with a relief valve housing or body 10 to form a unitary structure. A lower portion of the body 10 is constructed to form an auxiliary water releasing channel 11 that is substantially parallel thereto. Inside the body 10, a valve block 14 is set for closing a return flow channel 13 at a water discharge side and is subjected biasing induced by a resilient element 12. An end of the valve block 14 drives a slide block 15 to abut against a water inlet fitting 16 to selectively block or open water inflow. A spring 17 is mounted to the end of the valve block 14 to oppose an inner end bore of the slide block 15 for biasing a sphere 18 to close a water inlet opening. The return flow channel 13 at the water discharge side is provided therein with a low-pressure relief and back-flow device, which is comprised of a simple structure comprising a spring 19 biasing a blockade 20 to effect secured closing operation after relief of pressure. In the portion of the body 10 at the water inlet side, a communication passage 21 is formed to communicate the water releasing channel 11 in the lower portion. A safety water releasing device is arranged inside the water releasing channel 11, comprising a collar 22 forming a central through hole that receives a filter can 23 to form a passage for filtration and flowing and an upper disk 24 and a block 25 stacked together to constitute a disk set positioned at an inner end of the collar 22, whereby with a tapered hole 26 and a flow guide slot 27, which are respectively formed in the upper disk 24 and the block 25 of the disk set, corresponding to and communicating each other, the upper disk 24 and the block 25 together define a passage for guiding water flow that passes through the central filter can 23. The disk set is subjected, at an inner side thereof, to biasing of a resilient element 28, whereby in an initial phase of operation of the pump for supplying water, water inflow passes by an outer end portion of the slide block 15 to enter the interior of the body 10, further moving through the communication passage 21 to reach inside water releasing channel 11 and thus completely through the water releasing valve assembly. The resilient element 28 biases the disk set outwards to open the water passage through the channel so that water, after passing through the filter can 23, moves through the tapered hole 26 to the flow guide slot 27 and further flowing around a circumference of the block 25 to get into the return flow channel as an outflow. Due to the constraint set by the tapered hole, the flow rate of the outflow is less than that of the inflow of water to a substantial extent so that the interior of the body 10 is gradually pressurized to a proper pressure level, where the resilient element 28 is compressed and thus shortened, forcing the block 25 to abut against an opposing bottom end thereby closing the water releasing channel 11, which leads to continuous accumulation of water and pressurization inside the body. A complete flow passage configuration for spraying with water supplied and pressurized by a pump is thus constructed.

To apply to spraying operations, when water supply from the pump is cut off, with pressure stabilization effected by the body 10, proper water discharge control can be realized through the whole spraying operation. When water pressure drops to a level that corresponds to a force smaller than the spring force induced by the resilient element 28 of the valve assembly inside the auxiliary water releasing channel 11, such a pressure drop allows the resilient element 28 to drive the disk set outwards thereby forming a passage that allows water to flow. At this time, water within the water inlet side portion of the interior of the body 10 quickly flows through the communication passage 21 to get into the return flow channel 13 at an opposite side portion of the body 10 to discharge through the low-pressure relief and flow back device for returning to a water storage. With the pressure continuously dropping down, water discharge pressure from the body 10 is quickly lowered to such a level corresponding to a biasing force of the resilient element 12 and at such a moment, the valve block 14 is biased to drive the slide block 15 to close the water inlet opening and simultaneously open the water return passage at the water discharge side of the body 10 to allow the water pressure to efficiently drop to a minimum pressure level. With the incorporation of the low-pressure relief and flow back device, the internal pressure inside the body 10 can be lowered to the minimum level; also, with the incorporation of the auxiliary water releasing structure, the valve block 14 is allowed to operate the sphere 18 in such a way that when pressurization by the pump is stopped, with the disk set inside the water releasing channel 11 being opened for water releasing, the water inlet side is quickly depressurized whereby the resilient element 12 induces movement toward the water inlet side to close the water inlet opening thereby stopping water inflow. With the pressure of outflow continuously dropping down, water releasing and back flowing realized through the return flow channel 13 at the water discharge side allows efficient drop of pressure to thereby ensure complete stop of water outflow; and water is returned to the water storage through the returning passage. As such, collection and recycling of the unused water can be realized to ensure environmental protection and operation safety.

The present invention arranges, in a combined manner, the water releasing channel 11, which functions for assisting releasing of water, under the water discharge channel defined inside the body 10 in a fashion that fluid communication is established therebetween with the communication passage 21 formed at the water inlet side. Thus, when the operation of the pump is shut down during a spraying operation, the discharge water pressure drops down to a predetermined pressure level. For example for a regular spraying operation, in which the spraying pressure is as high as 30 kgf/cm², when the pump is shut down, the water pressure inside a water supply pipe is in a high-pressure condition and the spraying operation may continue; and when the pressure drops to a level lower than about 15 kgf/cm², the auxiliary water releasing valve assembly inside the water releasing channel 11 automatically opens to induce water releasing and pressure drop for the water inlet side, leading to immediate lowering of pressure so as to lower the internal pressure of the body 10 to about 8 kgf/cm², whereby due to the valve block 14 being resiliently biased toward the water inlet side and the sphere 18 closing the water inlet opening, the water flow return device of the body 10 allows the water to immediately flow outward through the return flow channel 13, leading to accelerated relief of pressure and immediate depressurization of the internal pressure of the body 10, and thus realizing a safe and dripping free operation and ensure effective control of spraying. Due to the stepwise relief of pressure, depressurization may be effected in both the water inlet side and the water discharge side of the body in a nearly synchronized manner. This not only provides spraying operations with practical effects of being safe, clean, and environmental protection, but the unitary configuration also helps simplifying the assembling thereof and enhancing the ease of assembling, requiring no skilled assembling technique, making the control of water spraying more sensitive and precise, water supply from the pump being made more smooth and stable in the operation thereof. The pressure relief and collection of unused water realized in the present invention by using the same return flow channel allow complete collection of the unused water without any waste.

To summarize, the fast back flow device of the relief valve in accordance with the present invention directly sets a back-flow water releasing channel in the valve body adjacent to the water inlet side and in communication with a return flow channel that is arranged at a water discharge side, whereby when the operation of pump is shut down, the water releasing device incorporated in the valve body allows for initial and immediate lowering of water pressure at the water inlet side to cut off water inflow and, when cooperating with the water returning and pressure lowering feature of the valve body, effects simultaneous water releasing and pressure lowering at both the water inlet side and water discharge side to ensure immediate drop of pressure inside the piping and eliminate water dripping at the water discharge end.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A fast back flow device of relief valve, comprising a relief valve body containing therein a resilient element, a valve block, and a water-blocking sphere for effecting control of pressure regulation and forming a return flow channel for pressure relief and an internally mounted pressure relief valve assembly operatively coupled thereto, characterized in that the body forms a passageway for water inlet and discharge and also forms a water releasing channel at a location under and in fluid communication with the passageway via a communication passage at a water inlet side of the body, wherein the water releasing channel is set in fluid communication with a return flow channel of the body to allow for re-collection of water released through the water releasing channel, whereby internal pressure inside the body can be released at both the water inlet side and a water discharge side of the body through the water releasing channel and the return flow channel respectively set at the water inlet side and the water discharge side to realize immediate relief of water pressure and collection and reuse of the released water.

2. The fast back flow device of relief valve according to claim 1, wherein the water releasing channel receives therein a pressure relief device comprised of a collar that form a through hole, stacked disk set that forms a flow passage, and a resilient element.

3. The fast back flow device of relief valve according to claim 2, wherein the through hole of the collar receives a filter can therein.

4. The fast back flow device of relief valve according to claim 2, wherein the disk set is formed by stacking an upper valve disk forming a tapered hole and a block forming a flow guide slot.

5. The fast back flow device of relief valve according to claim 4, wherein the tapered hole of the valve disk and the flow guide slot of the block correspond to and communicate each other to define the flow passage.
